(19) United States
(12) Patent Application Publication
(10) Pub. No.: US 2003/0173919 A1
(43) Pub. Date: Sep. 18, 2003

(54) Brake module

(76) Inventors: Wilfried Altendorf, Minden (DE); Karsten Barner, Minden (DE); Thomas Stiller, Nurnberg (DE); Franz Kirsch, Leinburg (DE)

Correspondence Address: ALTERA LAW GROUP, LLC, 6500 CITY WEST PARKWAY, SUITE 100, MINNEAPOLIS, MN, 55344-7704, US

(21) Appl. No.: 10/239,979

(22) PCT Filed: Mar. 14, 2001
(86) PCT No.: PCT/EP01/02854

(30) Foreign Application Priority Data
Mar. 23, 2000 (DE) 100 14 174.9

(51) Int. Cl. H02P 3/18

(52) U.S. Cl. 318/375

(57) ABSTRACT

The invention relates to a braking module for an asynchronous motor, in particular that used in a circular saw. In order that the braking process can run its course as gently and noiselessly as possible, independently of the inertial moment of the element driven by the motor, according to the invention provision is made for switching means (1, 2, 3, S1-S5) for separating the stator windings (U, V, W) of the asynchronous motor from the operating-voltage supply (L1, L2, L3) and for applying a direct current voltage (G1, G2) to at least two stator windings (U, V) in order to brake the asynchronous motor, a measuring unit (9) for measuring a remanence voltage on at least one stator winding (W), and a control unit (12) for regulating a braking current, which, for the purpose of braking, flows through the stator windings affected by the direct current voltage, in dependence on the measured remanence voltage. In further developments, provision is made for the regulation of the braking current by means of a predetermined value table or in an adaptive manner.

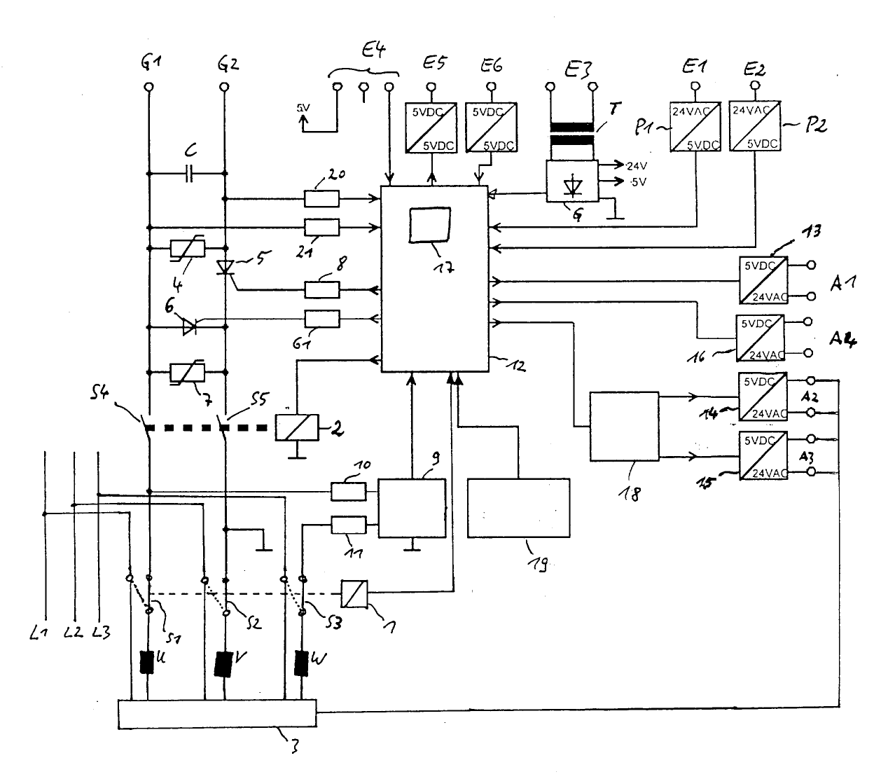

The invention relates to a brake module for an asynchronous motor, especially an asynchronous motor used in a circular saw for driving the saw blade. The invention further relates to a corresponding method for braking an asynchronous motor.

Different possibilities are known for braking the saw blade of a circular saw. In a so-called compression-spring single-disc brake, in order to brake, a friction disc is pressed against a motor flange, so that the saw blade is braked through mechanical friction.

In addition, different methods are known for electrical braking of the asynchronous motors generally used in circular saws to drive the saw blade, such as, in particular, the so-called direct current brake and the countercurrent brake. In a direct current brake, the stator windings of the asynchronous motor are separated from the operating-voltage supply, which as a rule displays three-phase current leads, and a direct current is applied to two stator windings. Through the direct current flowing in these stator windings, a magnetic constant field is generated in the interior of the rotor, whereby, due to the rotational movement of the rotor of the asynchronous motor, a voltage is induced in the rotor windings. The current arising in the rotor then forms, along with the magnetic constant field, the braking moment for braking the asynchronous motor.

For the countercurrent brake, the motor is disconnected from the rotating-current [three-phase] network and reconnected after reversal of the polarity of the leads of two stator windings. By this means the direction of rotation of the magnetic rotating field is reversed, while the direction of rotation of the rotor at first remains unchanged. Since the asynchronous motor is now driven against the rotating field, a greater rotor current flows and the motor attempts to change its direction of rotation, in order to follow the rotating field. Thus, the rotor will change the direction of rotation after the braking, so long as no disconnection takes place upon the reaching of a null rotational speed.

Since in a circular saw very different inertial moments arise, conditioned through different rotational speeds (3000 to 6000 rpm) and different saw blade diameters (250 to 450 mm), great demands are placed on a braking module. The braking process must, despite the different inertial moments, run its course in a gentle and noise-free manner and may not be abrupt. The known braking modules do not fulfill these requirements. Mechanical braking modules are noisy, difficult to control, and encumbered by wear and tear. Electrical braking modules that brake according to the direct current method use a rigidly set braking current, so that the braking is too rapid or slow, depending on the magnitude of the inertial moment to be retarded. Braking modules that operate according to the method of the countercurrent brake are likewise not controllable according to the inertial moment and, in addition, brake very abruptly.

Thus, the invention is based on the task of creating a braking module for an asynchronous motor, especially for a circular saw with an asynchronous motor for driving the saw blade, which module makes possible a gentle and low-noise braking. According to the invention, this task is accomplished through a braking module according to claim 1.

In accomplishing the task, the invention begins with the recognition that, by means of remanence voltage measured on at least one stator winding, the braking current, which flows through the stator windings affected by the direct current voltage, can be controlled such that a gentle braking is achieved. By “remanence voltage” is to be understood here the voltage at a stator winding that is induced in the stator windings by the rotor rotating in the magnetic field of the stator. This voltage is generally known as counter-EMF (electromotive force). Depending on this remanence voltage, which can be measured once or several times during the braking process, the braking current can be set or controlled so that the asynchronous motor is braked in a pre-determined braking time, regardless of the magnitude of the inertial moment of the element driven by the asynchronous motor. The requirement for circular saws contained in regulation EN1870-1, according to which the braking time must be less than 10 seconds, can be fulfilled by means of a braking module according to the invention with different saw blades with different diameters and/or masses and/or rotational speeds. In practical implementations, braking times between 3 and 9 seconds were achieved.

Advantageous configurations of the braking module according to the invention are specified in the dependent claims.

In the especially advantageous configuration according to claim 3, the remanence voltages appearing immediately before or during braking are measured in advance for different asynchronous motors, which have different motor outputs and/or operating voltages, and/or for different elements to be driven, e.g. for different saw blades, and appropriate braking programs are determined. In such braking programs it is established how a particular motor, or a particular element to be driven, must be braked in order to achieve a gentle braking, i.e. by which braking currents it must be braked. These braking programs are stored in a memory and can be called up during operation. The selection of the braking program depends here on the motor used, which can be preset as a setting in the braking module, and/or on the remanence voltage measured immediately before or during the braking.

In the advantageous development according to claim 4, as an alternative a complete braking program dependent on the motor used and/or on the measured remanence voltage is not selected, which program contains the control of the braking current during the entire braking time, but rather, depending on the precisely current, measured remanence voltage, a selection is made from a memory of the braking current appropriate for this voltage. Since the measuring of the remanence voltage can take place multiple times at definite time intervals, after each measurement the braking current can be readjusted in an optimal manner according to the particular conditions.

According to the alternative configuration according to claim 6, the determination of the braking current can also take place adaptively according to the current, measured remanence voltage. This means that it is not necessary to measure, prior to the start of the operation, different motors and/or different inertial moments in order to determine appropriate braking programs or the necessary braking currents and to store these in a memory in tabular form. Rather, multiple times during the braking process the remanence voltage is measured, and from this, and possibly from the stored motor data, is adaptively determined the magnitude of the braking current necessary to achieve the desired braking behavior. For this purpose, according to the invention an appropriate regulating circuit is planned.

In the advantageous configuration according to claim 7, the direct current voltage, which is applied to at least two stator windings for braking, is generated from the operating voltage, i.e. generally an alternating voltage, through rectification. According to this configuration, before the start of the braking process the remanence voltage is measured at one stator winding and it is determined whether the amplitude of the remanence voltage lies below a predetermined threshold and whether the polarity of the remanence voltage is correct for the recovery diode. If these conditions are met, the braking is initiated by application of the direct current voltage.

The invention also relates to a circular saw, especially a format circular saw, that displays a braking module according to the invention. In addition, the invention relates to a method for braking an asynchronous motor, which method is specified in claim 13. The circular saw and this method can be further developed according to the invention and in a manner corresponding to the braking module.

In the following, the invention is explained in detail with the aid of the block circuit diagram, shown in the FIGURE, of a braking module according to the invention.

As a rule, a circular saw displays an asynchronous motor, the three stator windings (U, V, W) of which are shown in the block circuit diagram. These windings, in the operating case, are supplied by a three-phase current line with three current leads L1, L2, L3, for which purpose the switches S1, S2, S3 are in the position drawn with dotted lines. In order to enable the asynchronous motor to be operated in wye or delta connection, provision is made for switching means 3 that are controlled by a central control unit 12 via a wye relay and a delta relay (outputs A2, A3) with switching means (not shown). For the braking of the motor, the windings U, V, W are separated from the leads L1, L2, L3 as the switches S1, S2, S3 are brought into the shown position by means of a relay 1 controlled by the control unit 12.

In the braking state, a direct current voltage is applied to the stator windings U, V, for which the switches S4, S5 are closed by means of a braking relay controlled by the control unit 12. For this purpose, a direct current voltage supplied by a known direct current source can be used, in which case the braking current flowing through the stator windings U, V must be controllable. Alternatively, as in the case shown an alternating voltage can also be used, for example from the leads L1 and L2 of the three-phase current line, which alternating voltage is applied to the connections G1, G2 and converted into a rectified voltage. For this purpose, in the present case provision is made for a capacitor C, two varistors 4, 7, and a thyristor 6 (or, alternatively, a recovery diode) that is controllable by the control unit 12 via a resistance 61. These also effect a clipping of the voltage peaks.

For controlling the braking current, provision is made in the connection lead between the connection G2 and the stator winding V for a further thyristor 5, which can be controlled by the control unit 12 via a resistance 8. By this means, the braking current flowing through this lead can be controlled, especially with respect to its current strength and duration, which influences the strength and time length of the braking current.

Further, connected to input E1 is a circuit breaker, which is connected to the control unit 12 via a voltage divider P1. Connected to input E2 is a motor relay, which is likewise connected to the control unit via a voltage divider. Adjoining input E3 is an alternating voltage supply, e.g. 24V AC, by which, via a transformer T and a rectifier G, the control unit 12 and other elements are supplied with direct current voltage. Connected to input E4 is an element for sensing the temperature of the motor winding, e.g. a PTC [positive temperature coefficient], which is used for protection of the motor against overheating. This input E4 is designed such that a second motor can also be connected.

In addition, provision is made for serial interfaces E5, E6 as communication interfaces for bi-directional data exchange with the machine control system. By this means, an error display of the braking module can also be realized, in order to prevent altogether a starting of the motor in the case of some errors, which in a saw motor is of particular importance. In addition, via these interfaces E5, E6, an automatic adaptation of the braking parameters to the particular tool diameter can take place by means of a data exchange with the machine control system, so that a gentle braking is ensured in every case.

Coupled to the outputs A1 to A4, which are connected in each case to the control unit 12 via a switching element (not shown), e.g. a relay and/or a fuse, and via, in each case, a voltage divider 13 and 16, are different protection devices, such as, in particular, a motor relay lock (output A1), a wye relay (A2), a delta relay (A3), and a temperature relay (A4). For selection of the wye or delta relays and for appropriate starting, provision is made for a corresponding wye-delta starting module 18. By means of a bridge-field motor selection block 19, which is coupled to the control unit 12, a rough parameter pre-selection for certain tasks can be made.

For determination of the remanence voltage, provision is made for a measurement unit 9, which is connected to the control unit 12. By means of this unit, the remanence voltage at stator winding U can be measured via a resistance 10, and the remanence voltage at stator winding W via a resistance 11.

The braking process in the braking module according to the invention will be explained in detail in the following. The motor power and the operating voltage of the motor are entered or stored in the control unit 12 in a suitable manner. When the braking process is to initiated through actuation of the cut-out switch of the saw, first of all the line relay (not shown) falls into the rest position. At the same time, the stator windings U, V, W are separated from the three-phase current line L1, L2, L3 through the throwing of the switches S1, S2, S3. As soon as the rest position of the line relay is recognized, the remanence voltage at the stator winding U is measured by the measurement device 9 via the resistance 10. The phase position and the amplitude of the remanence voltage are simultaneously evaluated in the control unit 12. If the amplitude of the remanence voltage is below a predetermined threshold (e.g. less than 70 volts) and the phase position of the remanence voltage corresponds to the polarity of the thyristor 6, then the braking process is begun, for which purpose the switches S4 and S5 are closed. Also, at the same time, the wye stage is activated, i.e. the stator windings U, V, W are operated in a wye circuit.

The braking program that is to be executed is selected, depending on the pre-entered motor output and operating voltage, from a table stored in a memory 17 in the control unit 12. There, different braking programs for different motors are stored in tabular form. The braking current is then immediately driven up to a first predetermined level by means of a ramp. This braking current is held constant until a first threshold of the remanence voltage is reached. The reaching of this threshold is monitored by the measurement device 9 via the resistance 11 at the stator winding W not affected by the direct current, at which winding the remanence voltage is measured. When the first threshold of the remanence voltage is reached, the braking current is driven down to a second predetermined braking current, until a second threshold of the remanence voltage at the stator winding W is reached. This stepwise lowering of the braking current according to the threshold values of the remanence voltage can take place at any frequency whatever, according to the desired step height and number of steps, until a standstill monitor (not shown) reports that the motor has stopped.

By means of the braking module according to the invention, a gentle and low-noise braking, within a predetermined braking time and independent of the inertial moment of the element just driven, can be achieved.

The braking module according to the invention can also be configured such that stored in a memory 17 are not particular braking programs, but rather only braking currents dependent on measured remanence voltages. In this case, during the braking process the remanence voltage is measured at defined time intervals and, in each case, the braking current appropriate to the remanence voltage is read from the table stored in the memory, which braking current is then established at the thyristor 5 by way of the resistance 8.

Further, provision can also be made for an adaptive regulation, by which the memory 17 and the prior determination of braking currents and/or braking programs for different motors and/or remanence voltages can be dispensed with. In this case, the required braking current is determined from the measured remanence voltage according to an appropriate algorithm, which current is established via the thyristor. The motor output and the desired braking time can also be entered into this algorithm.

In the configuration shown, provision is also made for two resistances 20, 21 for an additional voltage and phase monitoring. These resistances 20 and 21 are connected to the connection lead between the terminal G1 and phase U, and to the connection lead between the terminal G2 and phase V, respectively, and lead to the control unit 12. On the one hand, by this means it can be checked how high the present voltage is, in order to carry out a braking curve correction based on the measured voltage level. Thereby, an additional intervention on the braking curve determined with the aid of the measured remanence voltage can be undertaken.

In addition, by means of these resistances 20, 21 a phase monitoring in the mentioned connection leads can also be realized. In the event of incorrect phase position of the voltage present there or in the event of completely missing phase, for example, an overdriving of the motor can be thereby completely avoided.

The invention is not limited to the exemplar embodiment shown. Rather, with respect to the concrete configurations, numerous variations are imaginable. In particular, the asynchronous motor can display more than three stator windings, or it can be designed as a single-phase motor. Also, the generation of the direct current voltage and the elements used for this purpose, as well as the elements for establishing the braking current and for measurement of the remanence voltage, can be varied.

1. Braking module for an asynchronous motor with switching means for separating the stator windings of the asynchronous motor from the operating-voltage supply and for applying a direct current voltage to at least two stator windings in order to brake the motor, which module comprises a measuring unit for measuring a remanence voltage on at least one stator winding and a control unit for regulating a braking current that flows through the stator windings affected by the direct current voltage, which regulation is dependent on the measured remanence voltage.

2. Braking module according to claim 1, characterized in that, for the purpose of regulating the braking current, the measuring unit is designed for measurement of the remanence voltage at regular time intervals.

3. Braking module according to one of the previous claims, characterized in that the control unit is designed for controlling the braking current corresponding to a braking program stored in a memory, which program is established in advance for different asynchronous motors and/or different elements to be driven, the braking program being selected in dependence on the measured remanence voltage and/or the motor-output data entered.

4. Braking module according to one of the previous claims, characterized in that the control unit is designed for selecting the braking current from those stored in the memory for different remanence voltages, depending on the currently measured remanence voltage.

5. Braking module according to one of the previous claims, characterized in that the control unit is designed for stepwise changing of the braking current.

6. Braking module according to one of the previous claims, characterized in that the control unit is designed for adaptive adjustment of the braking current depending on the currently measured remanence voltage.

7. Braking module according to one of the previous claims, characterized in that the control unit is designed for measuring the remanence voltage at a first stator winding before the beginning of the braking process, and that the switching means are designed for separating the stator windings from the operating-voltage supply and for applying a rectified direct-current voltage, generated from the operating voltage, when the phase position of the remanence voltage corresponds to that of the operating voltage used to generate the direct current voltage.

8. Braking module according to one of the previous claims, characterized in that means for standstill monitoring, for wye/delta switchover, and for monitoring the winding temperature of the motor are integrated into the braking module.

9. Braking module according to one of the previous claims, characterized in that the control unit is designed such that the motor is braked in less than 10 seconds.

10. Braking module according to one of the previous claims, characterized in that the braking module is integrated with a gentle-start module in a single compact unit.

11. Braking module according to one of the previous claims, characterized in that provision is made for means for braking-current correction and/or for phase monitoring.

12. Circular saw, in particular format circular saw, with a braking module according to one of the previous claims.

13. Method for braking an asynchronous motor in which, for the purpose of braking, the stator windings are separated from the operating-voltage supply and a direct current voltage is applied to at least two stator windings, in which method a remanence voltage is measured on at least one stator winding and a braking current, which, for the purpose of braking, flows through the stator windings affected by the direct current voltage, is regulated according to the measured remanence voltage.
